(19) United States
(12) Patent Application Publication
(10) Pub. No.: US 2024/0416351 A1
(43) Pub. Date: Dec. 19, 2024

(54) WELL ASSEMBLIES AND RELATED METHODS

(71) Applicant: ILLUMINA, INC., San Diego, CA (US)

(72) Inventor: Paul Crivelli, San Diego, CA (US)

(21) Appl. No.: 18/689,691

(22) PCT Filed: Sep. 9, 2022
(86) PCT No.: PCT/US2022/043073

§ 371 Date: Mar. 6, 2024

Related U.S. Application Data
(60) Provisional application No. 63/244,034, filed on Sep. 14, 2021.

(51) Int. Cl. B01L 3/00

(52) U.S. Cl. CPC B01L 3/50853; B01L 2200/0684; B01L 2200/16; B01L 2300/041; B01L 2300/048; B01L 2300/0858

(57) ABSTRACT

Well assemblies and related methods are disclosed. In accordance with an implementation, an apparatus includes a well assembly including a body and an insert. The body has a well and the insert includes a sidewall defining an opening and a venting membrane coupled to the insert and extending across the opening. The insert is received within the well and wherein a coupling is formed between the sidewall of the insert and the body.

### RELATED APPLICATION SECTION

This application claims the benefit of and priority to U.S. Provisional Patent Application No. 62/244,034, filed Sep. 14, 2021, the content of which is incorporated by reference herein in its entirety and for all purposes.

### BACKGROUND

Reagent cartridges used with, for example, sequencing platforms, may include liquid reagent that is kept frozen until use. Keeping the reagent frozen may involve using additional packaging and/or dry ice when transporting the reagent and may involve keeping the reagent within a freezer at a facility. The measures taken to keep the reagent frozen can raise the cost of shipping and may cause some facilities to purchase additional or larger freezers or other equipment to store the reagent cartridges. Moreover, the use of ice packs, dry ice, and/or additional packaging when shipping frozen reagent may reduce sustainability and increase waste. Furthermore, significant amounts of time may be taken to defrost the frozen reagent prior to use.

### SUMMARY

Shortcomings of the prior art can be overcome and advantages and benefits as described later in this disclosure can be achieved through the provision of well assemblies and related methods. Various implementations of the apparatus and methods are described below, and the apparatus and methods, including and excluding the additional implementations enumerated below, in any combination (provided these combinations are not inconsistent), may overcome these shortcomings and achieve the advantages and benefits described herein.

In accordance with a first implementation, an apparatus includes a well assembly including a body and an insert. The body has a well and the insert includes a sidewall defining an opening and a venting membrane coupled to the insert and extending across the opening. The insert is received within the well and a coupling is formed between the sidewall of the insert and the body.

In accordance with a second implementation, a method includes depositing dry reagent within a well of a reagent cartridge, positioning an insert within the well, and forming a coupling between the insert and the reagent cartridge. The insert includes a sidewall having an opening and a venting membrane coupled to the insert and covering the opening.

In accordance with a third implementation, a method includes aspirating dry reagent into a dosator and positioning the dosator carrying the dry reagent into a well defined by a body. The method includes forming a coupling between the dosator and the body.

In accordance with a fourth implementation, an apparatus includes a well assembly including a body and an insert. The body has a well and the insert is received within the well and carries a venting membrane. A coupling is formed between the insert and the body.

In further accordance with the foregoing first, second, third, and/or fourth implementations, an apparatus and/or method may further include or comprise any one or more of the following:

In an implementation, the venting membrane is overmolded onto the insert.

In another implementation, the coupling is a snap-fit connection.

In another implementation, the coupling is a weld.

In another implementation, the apparatus includes dry reagent within the well.

In another implementation, the apparatus includes a cover coupled to the insert and covering the venting membrane.

In another implementation, the cover is a liquid impermeable barrier.

In another implementation, the liquid impermeable barrier includes foil.

In another implementation, the cover forms at least part of a dead end.

In another implementation, the cover is coupled to the well and forms an enclosure that captures gas that vents through the venting membrane.

In another implementation, the well is couplable to a pressure source.

In another implementation, the body includes a well wall defining the well and having a distal end and the cover is coupled to the distal end of the well wall.

In another implementation, the body includes one or more protrusions that extend into the well and the sidewall of the insert includes a groove that receives the one or more protrusions to form a snap-fit connection.

In another implementation, the one or more protrusions are radially spaced and the groove includes an annular groove.

In another implementation, the well includes a first well portion and a second well portion, and the insert is received within the first well portion.

In another implementation, the body forms a shoulder that is engaged by the insert.

In another implementation, the apparatus includes dry reagent within the second well portion.

In another implementation, the first well portion and the second well portion are concentric.

In another implementation, the sidewall has a first end, a second end, and a second opening, the opening positioned at the first end of the sidewall and the second opening positioned at the second end of the sidewall. The apparatus also includes a cover coupled to the second end of the sidewall and covering the second opening.

In another implementation, the insert is a dosator.

In another implementation, the well includes dry reagent and the sidewall and the venting membrane define a chamber portion in which dry reagent is housed.

In another implementation, the insert includes the sidewall and an inward projecting flange and the venting membrane is coupled to the inward projecting flange.

In another implementation, the inward projecting flange, the venting membrane, and the sidewall form a chamber portion having an opening.

In another implementation, the chamber portion is received within the well and the apparatus also includes dry reagent within the chamber portion.

In another implementation, the opening of the chamber portion faces a base surface of the reagent cartridge defining the well.

In another implementation, the body includes a port coupled to the well.

In another implementation, the body includes an inward tapered surface that extends toward the port and defines the well.

In another implementation, the body includes a well wall that defines the well and has a distal end and the insert is positioned within a dimensional envelope of the well.

In another implementation, a cover is coupled to the distal end of the well wall.

In another implementation, the insert extends outside of a dimensional envelope of the well.

In another implementation, the body of the reagent cartridge does not include a port.

In another implementation, the body includes a plurality of wells, each receiving a corresponding insert.

In another implementation, each of the wells includes a port.

In another implementation, the wells do not include a port.

In another implementation, forming the coupling between the insert and the reagent cartridge includes forming a snap-fit connection between the insert and the reagent cartridge.

In another implementation, forming the coupling between the insert and the reagent cartridge includes ultrasonically welding the insert and the reagent cartridge.

In another implementation, depositing the dry reagent within the well of the reagent cartridge includes depositing the dry reagent within a first well portion of the well and positioning the insert within the well includes positioning the insert within a second well portion of the well that is concentric with the first well portion.

In another implementation, depositing the dry reagent within the well includes aspirating the dry reagent into a chamber portion of the insert and positioning the insert into the well.

In another implementation, the venting membrane is located within the insert to define a volume of the chamber portion.

In another implementation, the method includes covering the dry reagent with a liquid impermeable barrier.

In another implementation, covering the dry reagent with the liquid impermeable barrier includes heat sealing the liquid impermeable barrier to a distal end of the insert and the reagent cartridge.

In another implementation, covering the dry reagent with the liquid impermeable barrier includes heat sealing the liquid impermeable barrier to a distal end of the insert.

In another implementation, the method includes depositing dry reagent within a second well of the reagent cartridge; positioning a second insert within the second well; and forming a coupling between the second insert and the reagent cartridge.

In another implementation, the method includes positioning the dosator within a receptacle of a tool and aspirating the dry reagent into the dosator includes generating a vacuum using the tool to aspirate the dry reagent into the dosator.

In another implementation, positioning the dosator within the receptacle of the tool includes coupling the dosator within the receptacle based on the vacuum generated.

In another implementation, the method includes releasing the dosator from within the receptacle of the tool after the coupling between the dosator and the body is formed.

In another implementation, positioning the dosator within the receptacle of the tool includes coupling the dosator within the receptacle based on an interference fit between the tool and the dosator.

In another implementation, forming the coupling between the dosator and the body includes forming a snap-fit connection between the dosator and the body.

In another implementation, aspirating the dry reagent into the dosator includes controlling an amount of the dry reagent received within a chamber portion of the dosator based on a location of a venting membrane within the dosator.

In another implementation, the method includes coupling a cover to the dosator and covering the venting membrane.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a cross-sectional view of an implementation of a well assembly that can be used to implement the well assembly of FIG. 1.

FIG. 3 is a cross-sectional view of an implementation of a plurality of well assemblies that can be used to implement the well assembly of FIG. 1.

FIG. 4 is a cross-sectional view of an implementation of a plurality of well assemblies that can be used to implement the well assembly of FIG. 1.

FIG. 5 illustrates a cross-sectional view of a tool gripping the end of the insert and creating a vacuum in a direction generally indicated by arrow to draw dry reagent from a container into the chamber portion of the insert.

FIG. 6 illustrates a cross-sectional view of the tool holding the insert carrying the dry reagent positioned above the well of the body and the insert being moved toward the well in a direction generally indicated by arrow.

FIG. 7 illustrates a cross-sectional view of the insert positioned within the well and a cover being aligned with the insert prior to the cover being coupled to the insert.

FIG. 8 illustrates a cross-sectional view of the insert positioned within the well and the cover coupled to the end of the insert.

FIG. 9 is a cross-sectional view of another tool that can be used to assemble the well assemblies disclosed.

FIG. 10 is a cross-sectional view of another tool that can be used to assemble the well assemblies disclosed.

FIG. 11 is a cross-sectional view of an implementation of a well assembly that can be used to implement the well assembly of FIG. 1.

FIG. 12 is a cross-sectional view of an implementation of a well assembly that can be used to implement the well assembly of FIG. 1.

FIG. 13 is a cross-sectional view of an implementation of a well assembly that can be used to implement the well assembly of FIG. 1.

FIG. 14 is a cross-sectional view of an implementation of a well assembly that can be used to implement the well assembly of FIG. 1.

FIG. 15 illustrates a flowchart for a method of assembling the well assemblies of FIGS. 1, 2, 3, 4, 5, 6, 7, 8, 9, 10, 11, 12, 13, 14, or any of the disclosed implementations.

FIG. 16 illustrates a flowchart for a method of assembling the well assemblies of FIGS. 1, 3, 4, 5, 6, 7, 8, 9, 10, 13, 14, or any of the disclosed implementations.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

At least one aspect of this disclosure is directed toward reagent cartridges including wells containing dry reagent and inserts that are coupled within the wells using, for example, a snap-fit connection or other methods. The reagent cartridge includes well walls that define the wells and each insert includes a sidewall having a first opening that is covered by a venting membrane and a second opening that is covered by a liquid impermeable barrier that prevents or at least substantially prevents moisture ingress and the dry reagent from being inadvertently rehydrated. The venting membrane is coupled to the insert and the liquid impermeable barrier may be foil and can also be coupled to the well wall of the reagent cartridge.

In some implementations, the well includes a first well portion that receives the dry reagent and a second well portion that is concentric with the first well portion and receives the insert. The well wall may form a shoulder that is engaged by the insert and positions the venting membrane over the dry reagent. In such implementations, the dry reagent may be deposited within the first well portion prior to the insert being received within the well.

In other implementations, the insert is a dosator cup and includes an inward projecting flange forming the first opening of the insert and to which the venting membrane is coupled. The insert includes a chamber and the flange and the venting membrane separate the chamber into a first chamber portion that receives the dry reagent and a second chamber portion. To form the assembly including the reagent cartridge, the insert, and the dry reagent, a dosating tool having an arm can be used that grips and forms a pneumatic seal/vacuum with a top portion of the insert, thereby allowing dry reagent to be aspirated/drawn into the first chamber portion of the insert. The arm of the robot can then position the insert within the well of the reagent cartridge and also deposit the dry reagent within the well. The liquid impermeable barrier may be coupled to the insert and/or the reagent cartridge after the insert is positioned within the well and the robot releases the insert.

Advantageously, using the disclosed implementations allow the dry reagent to be metered, administered within a well, and sealed in a single manufacturing process while also housing and/or containing the dry reagent within a lower portion of the corresponding wells, thereby more likely ensuring that the dry reagent is able to be rehydrated and/or does not drop into the rehydrating liquid in clumps. Moreover, the disclosed implementations allow wells to be filled, covered, and/or sealed with an insert and/or covered sequentially and/or in a manner that reduces cross contamination and/or reduces an amount of time that the dry reagent is exposed to the environment.

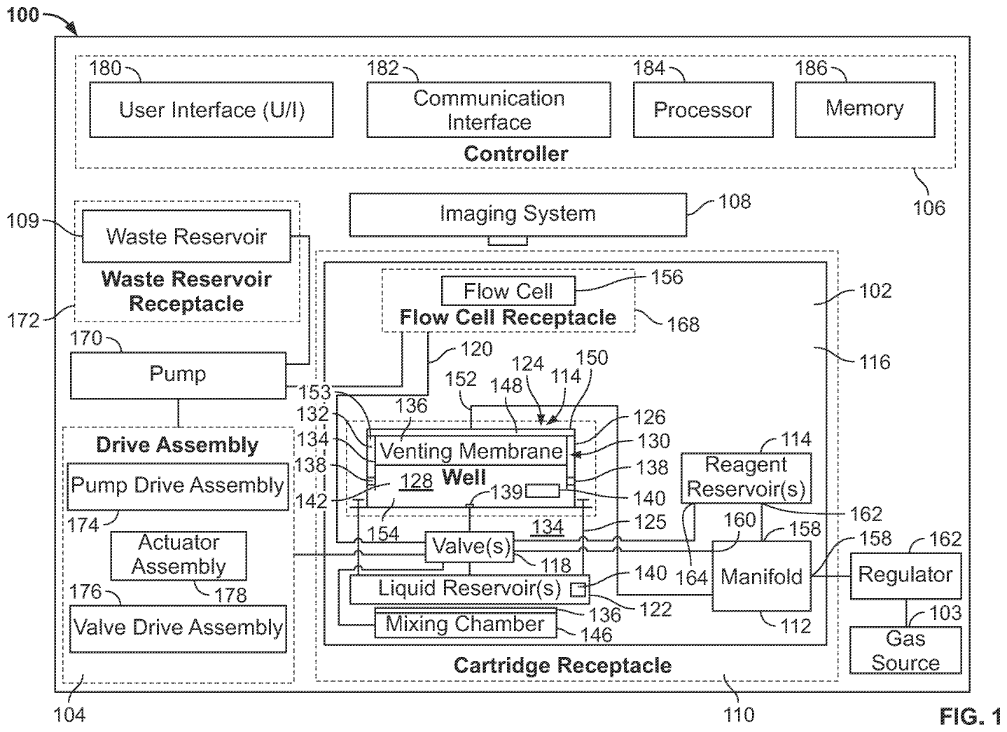

FIG. 1 illustrates a schematic diagram of an implementation of a system 100 in accordance with the teachings of this disclosure. The system 100 can be used to perform an analysis on one or more samples of interest. The sample may include one or more DNA clusters that have been linearized to form a single stranded DNA (sstDNA). In the implementation shown, the system 100 receives a reagent cartridge 102 and includes, in part, a gas source 103, a drive assembly 104, a controller 106, an imaging system 108, and a waste reservoir 109. The controller 106 is electrically and/or communicatively coupled to the drive assembly 104 and to the imaging system 108 and causes the drive assembly 104 and/or the imaging system 108 to perform various functions as disclosed herein.

The reagent cartridge 102 carries the sample of interest. The gas source 103 may, in some implementations, be used to pressurize the reagent cartridge 102 and the drive assembly 104 interfaces with the reagent cartridge 102 to rehydrate dry reagents and to flow one or more liquid reagents (e.g., A, T, G, C nucleotides) through the reagent cartridge 102 that interact with the sample. The gas source 103 may be provided by the system 100 and/or may be carried by the reagent cartridge 102. Alternatively, the gas source 103 may be omitted.

In an implementation, a reversible terminator is attached to the reagent to allow a single nucleotide to be incorporated onto a growing DNA strand. In some such implementations, one or more of the nucleotides has a unique fluorescent label that emits a color when excited. The color (or absence thereof) is used to detect the corresponding nucleotide. In the implementation shown, the imaging system 108 excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 108 may be a fluorescence spectrophotometer including an objective lens and/or a solid-state imaging device. The solid-state imaging device may include a charge coupled device (CCD) and/or a complementary metal oxide semiconductor (CMOS).

After the image data is obtained, the drive assembly 104 interfaces with the reagent cartridge 102 to flow another reaction component (e.g., a reagent) and/or gas through the reagent cartridge 102 that is thereafter received by the waste reservoir 109 and/or otherwise exhausted by the reagent cartridge 102. In an implementation, the reagent and the gas is alternatingly flowed through the reagent cartridge 102. The reaction component and the gas may perform a flushing operation that chemically cleaves the fluorescent label and the reversible terminator from the sstDNA. The sstDNA is then ready for another cycle.

Referring to the reagent cartridge 102, in the implementation shown, the reagent cartridge 102 is receivable within a cartridge receptacle 110 of the system 100 and includes a manifold 112, reagent reservoirs 114, a body 116, one or more valves 118, and fluidic lines 120. In other implementations, the reagent cartridge 102 does not include the manifold 112. The reagent reservoirs 114 may contain fluid (e.g., reagent and/or another reaction component) and the valves 118 may be selectively actuatable to control the flow of fluid through the fluidic lines 120. One or more of the valves 118 may be implemented by a valve manifold, a rotary valve, a pinch valve, a flap valve, a solenoid valve, a check valve, a piezo valve, etc. If a rotary valve is used, the reagent cartridge 102 and/or the system 100 may include the valve(s) 118.

The body 116 may be formed of solid plastic using injection molding techniques and/or additive manufacturing techniques. In some implementations, the reagent reservoirs 114 are integrally formed with the body 116. In other implementations, the reagent reservoirs 114 are separately formed and coupled to the body 116. The reagent reservoirs 114 and/or the reagent cartridge 102 may include polypropylene and/or cyclic olefin copolymer (COC) with an overmolded Santoprene™ thermoplastic elastomer (TPE) or another thermoplastic elastomer. Other materials may prove suitable for the reagent reservoirs 114 and/or the reagent cartridge 102.

In the implementation shown, the reagent cartridge 102 includes a liquid reservoir 122 and one or more of the reagent reservoirs 114 include a well assembly 124 couplable to the liquid reservoir 122. The liquid reservoir 122 and/or the well assembly 124 may be considered modular components that may be coupled together using a coupling 125 such as a snap-fit connection or another fastener. Alternatively, the liquid reservoir 122 and the well assembly 124 may be separate components that are fluidically coupled but the coupling 125 itself may not be included.

The well assembly 124 includes a body 126 defining a well 128, an insert 130 including a sidewall 132 defining an opening 134, and a venting membrane 136 coupled to the insert 130 and extending across the opening 134. The venting membrane 136 may be a hydrophobic venting membrane, a hydrophilic venting membrane, and/or a screen. In some implementations, the screen may have holes having a diameter less than between about 0.4 mm and/or less than about 0.5 mm. However, screens having different hole shapes and/or sizes may prove suitable. For example, the holes may be approximately 30% larger than about 0.5 mm and/or about 30% less than about 0.5 mm. The venting membrane 136 may be coupled to the insert 130 by heat sealing, laser welding, ultrasonic welding, pressure-sensitive adhesive (PSA), or any other suitable method. Alternatively, the venting membrane 136 can be overmolded onto the insert 130.

As shown, the insert 130 is received within the well 128 and a coupling 138 is formed between the sidewall 132 of the insert 130 and the body 126. The coupling 138 may be a snap-fit connection or a weld such as, for example, a weld formed by ultrasonic welding. However, the coupling 138 may be formed in any suitable manner. The body 126 also includes a port 139 that is couplable to the liquid reservoir 122. The port 139 may be a septum or another fluidic connection. In other implementations such as with systems that include a sipper manifold assembly, the port 139 may be omitted.

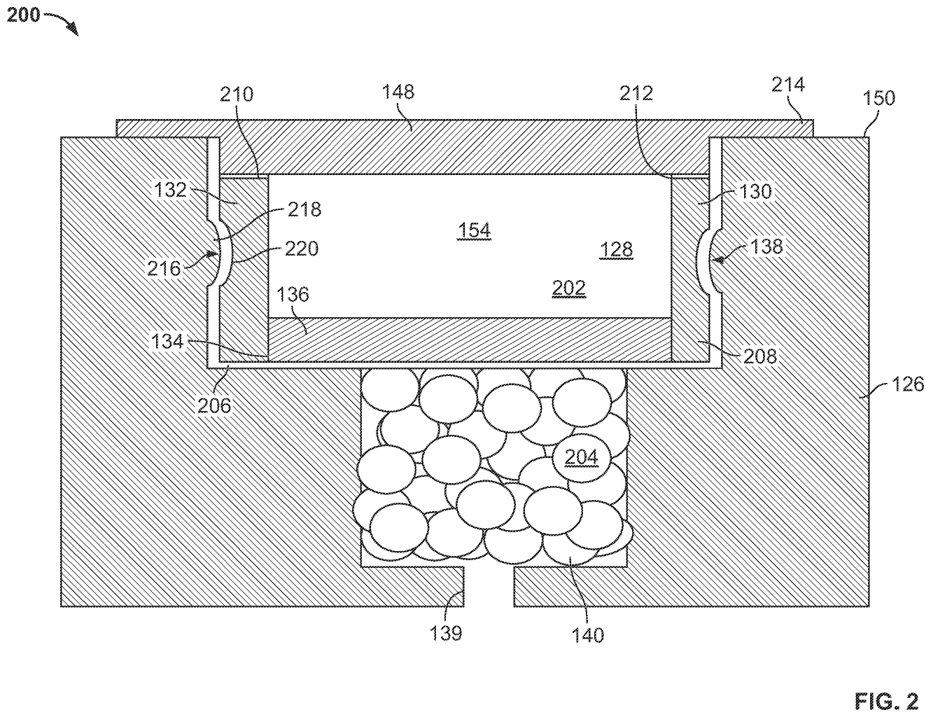

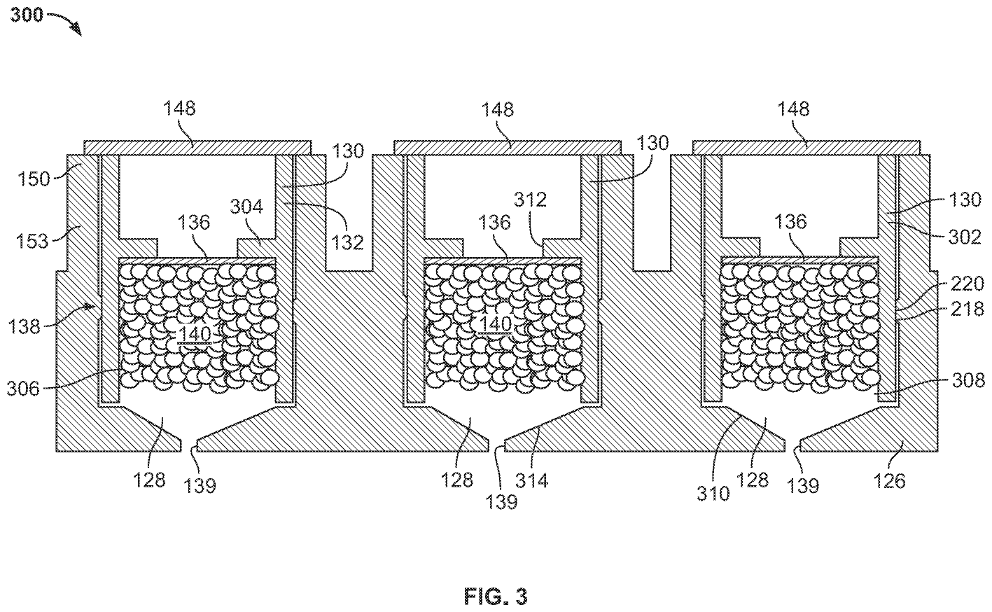

The insert 130 allows the well assembly 124 to be easily assembled, reduces, for example, an amount of time that dry reagent 140 is exposed to the environment prior to being positioned within the well 128, and enables the venting membrane 136 to be easily coupled and positioned within the well 128. In some implementations and as shown in FIG. 2, the dry reagent 140 is deposited into the well 128 prior to the insert 130 being positioned within the well 128 and, in other implementations and as shown in FIGS. 3-10, the insert 130 is a dosator and the dry reagent 140 is aspirated into the insert 130 prior to the insert 130 carrying the dry reagent 140 is positioned within the well 128. In such examples, the sidewall 132 of the insert 130 and the venting membrane 136 define a chamber portion 142 in which dry reagent 140 is housed.

The liquid reservoir 122 may contain liquid 144 such as a buffer or water and the well 128 may contain the lyophilized reagent (e.g., freeze-dried reagent) 140. The dry reagent 140 may be a cake, microspheres, and/or a powder. The venting membrane 136 may retain the dry reagent 140 within a lower portion of the well 128 and/or below the venting membrane 136 and may reduce movement of the dry reagent 140 within the well 128 during, for example, shipping and/or handling. Movement of the dry reagent 140 may cause the dry reagent 140 to become statically charged and cling to the body 126 of the well assembly 124, thereby adversely affecting the dry reagent 140 from rehydrating.

The venting membrane 136 also allows liquid 144 from the liquid reservoir 122 to be flowed into the well 128 as the venting membrane 136 vents gas contained within the well 128. Advantageously, the venting membrane 136 meters a precise volume of liquid within the well 128 by substantially preventing liquid from flowing therethrough while removing gas and/or bubbles from the well 128 and/or the liquid. As such, using the disclosed implementations, highly accurate and precise geometric metering is achieved by flowing liquid into the well 128 for a particular amount of time, at a particular pressure, and/or until a substantial pressure equilibrium is achieved between the gas source 103 and the well 128 without the use of a precision metering device such as a syringe pump. The well 128 can have a volume of approximately 10 microliters (μL) and/or up to the tens of milliliters (ml) (e.g., approximately 50 ml). However, the well 128 may have any other size. While the well 128 is shown coupled to the liquid reservoir 122, via the valve 118, in other implementations, the well 128 is directly coupled to the liquid reservoir 122. However, the well 128 and the liquid reservoir 122 can be coupled (e.g., fluidic coupling) in any suitable manner.

To mix the liquid 144 and the dry reagent 140, the liquid 144 and the dry reagent 140 can be flowed into and out of the well 128. The mixing process may occur by actuating the valve 118 to fluidically couple the liquid reservoir 122, the well 128, and/or a mixing chamber 146 and flowing the liquid 144 and the dry reagent 140 between the well 128 and one of the fluidic lines 120 or between the well 128 and the mixing chamber 146. Thus, the disclosed implementations may also be used to mix the liquid 144 and the dry reagent 140. The mixing chamber 146 is shown including a venting membrane 136 and, in some implementations, the mixing chamber 146 and/or the well 128 includes a mixer such as a magnet or a stir rod to further mix the liquid 144 and the dry reagent 140. Additionally or alternatively, the mixing chamber 146 may be dead ended. While the mixing chamber 146 is shown coupled to the valve 118, the mixing chamber 146 can alternatively be located upstream of the well 128 and/or disposed downstream of the well 128. However, the mixing chamber 146 may be positioned in a different location or omitted.

The liquid reservoir 122 may be filled with the liquid 144 prior to shipping or may be filled by an individual and/or the system 100 prior to use. Because the well 128 may house the dry reagent 140 and not liquid reagent, the well assembly 124 may be ambient shipped and/or stored. Such an approach may simplify storage requirements, reduce shipping costs, and increase the speed of workflows by, for example, avoiding thaw time before the reagent may be used. While the liquid reservoir 122 is mentioned housing liquid and the well 128 is mentioned housing dry reagent, the liquid reservoir 122 and/or the well 128 may contain another substance(s) (e.g., solids and/or liquids) or the liquid reservoir 122 and/or the well 128 may be empty.

In the implementation shown, the well assembly 124 includes a cover 148 coupled to the insert 130 and covering the venting membrane 136. The cover 148 may be a liquid impermeable barrier that reduces the likelihood and may even prevent dry reagent 140 contained within the well 128 from being inadvertently rehydrated, or at least reduces the rate at which the dry reagent 140 contained within the well 128 is rehydrated, via the ingress of moisture. The cover 148 may be a pierceable or removable cover including thin metal foil, such as aluminum foil, or by a thin plastic sheet(s), such as Saran™ wrap. However, the cover 148 may comprise or consist of other materials and/or other layering arrangements that substantially prevent moisture ingress into the dry reagent.

When the cover 148 is made of pierceable foil, the system 100 may pierce the cover 148 or the cover 148 may be pierced by an individual prior to use. In such implementations, the liquid 144 may be drawn out of the well 128 using negative pressure or a distal end 150 of the well 128 may be fluidically coupled to the gas source 103 and/or to a pressure source of the system 100 via a fluidic coupling 152. The fluidic coupling 152 may be a gasket interface that couples with the well 128 and/or the fluidic coupling 152 may be a collar that surrounds and/or is positioned at the distal end 150 of the well 128. The fluidic coupling 152 may also include a piercing member such as a conical protrusion that is used to pierce the cover 148 as and/or prior to the fluidic coupling 152 being formed.

In other implementations, the body 116 includes a well wall 153 that defines the well 128 and has the distal end 150 to which the cover 148 is coupled. The cover 148 is positioned over the opening 130 to form an enclosure 154 that captures the gas that vents through the venting membrane 136. The enclosure 154 can be a dead ended fluidic chamber having a known volume that captures the vented gas and creates a pressure source that can be used to flow the liquid 144 out of the well 128 in response to the valve 118 actuating and releasing the pressure. While the enclosure 154 is mentioned being a dead ended fluidic chamber, the enclosure 154 may also be pressurized by the gas source 103 via the fluidic coupling 152.

Referring now to the manifold 112, the manifold 112 is fluidically coupled to the gas source 103, one or more of the reagent reservoirs 114, and the valve 118. The coupling between the components 103, 112, 114, 116 allows gas (e.g., air) to pressurize the reagent cartridge 102 by flowing gas through the manifold 112 to the reagent reservoirs 114 and to the valve 118. The gas source 103 may pressurize the reagent to flow the reagent through the fluidic lines 120 under positive pressure, which increases the flow rate through the reagent cartridge 102 and/or decreases a response time to flow the reagent between the well 128 and the fluidic line 120, the well 128, and the mixing chamber 146, and/or into, for example, a flow cell 156. As used herein, a “flow cell” can include a device having a lid extending over a reaction structure to form a flow channel therebetween that is in communication with a plurality of reaction sites of the reaction structure. Some flow cells may also include a detection device that detects designated reactions that occur at or proximate to the reaction sites. More generally, pressurizing the reagent reservoirs 114 reduces cycle times of the system 100. Alternatively, one or more of the reagent reservoirs 114 may not be pressurized.

The manifold 112 includes an inlet 158 fluidically coupled to the gas source 103 and outlets 160 fluidically coupled to the valve 118 and one of the reagent reservoirs 114. In the implementation shown, one of the manifold outlets 160 may be fluidically coupled to an inlet 162 of the reagent reservoir 114 such that the manifold 112 is coupled to the valve 118 via the reagent reservoir 114. The reagent reservoir 114 also includes an outlet 164 fluidically coupled to the valve 118. The manifold 112 may alternatively be directly coupled to the valve 118 by the fluidic line 120. Other arrangements may prove suitable.

A regulator 166 can be positioned between the gas source 103 and the manifold 112 and regulates a pressure of the gas provided to the manifold 112. Alternatively, the regulator 166 may not be included. The regulator 166 may be implemented by a multi-channel regulator. In an implementation, the pressure applied to, for example, the reagent reservoir 114, is determined by calibrating a flow rate in the reagent cartridge 102 to a pressure of the gas source 103. However, the pressure may be selected in different ways. Alternatively, one or more regulators 166 may be positioned between the manifold 112 and the reagent reservoir 114 and/or between the manifold 112 and the valve 118.

The reagent cartridge 102 is in fluid communication with the flow cell 156. In the implementation shown, the flow cell 156 is carried by the reagent cartridge 102 and is received via a flow cell receptacle 168. Alternatively, the flow cell 156 can be integrated into the reagent cartridge 102. In such implementations, the flow cell receptacle 168 may not be included or, at least, the flow cell 156 may not be removably receivable within the reagent cartridge 102. As a further alternative, the flow cell 156 may be separate from the reagent cartridge 102.

While the above disclosure describes urging liquid and/or reagent into and out of the well 128 and/or through the flow cell 156 under positive pressure, liquid and/or reagent may alternatively be drawn through the flow cell 156 under negative pressure when, for example, the reagent reservoirs 114 are not pressurized. To do so, the system 100 may include a pump 170 positioned between the flow cell 156 and the waste reservoir 109. The waste reservoir 109 may be selectively receivable within a waste reservoir receptacle 172 of the system 100. The pump 170 may be implemented by a syringe pump, a peristaltic pump, a diaphragm pump, etc. While the pump 170 is shown being part of the system 100 and positioned between the flow cell 156 and the waste reservoir 109, in other implementations, the pump 170 may be positioned upstream of the flow cell 156, may be part of the reagent cartridge 102, or omitted entirely.

Referring now to the drive assembly 104, in the implementation shown, the drive assembly 104 includes a pump drive assembly 174, a valve drive assembly 176, and an actuator assembly 178. The pump drive assembly 174 interfaces with the pump 170 to pump fluid through the reagent cartridge 102 and the valve drive assembly 176 interfaces with the valve 118 to control the position of the valve 118. The actuator assembly 178 interfaces with the cover 148 to pierce the cover 148 when the cover 148 is formed of foil or another pierceable material.

Referring to the controller 106, in the implementation shown, the controller 106 includes a user interface 180, a communication interface 182, one or more processors 184, and a memory 186 storing instructions executable by the one or more processors 184 to perform various functions including the disclosed implementations. The user interface 180, the communication interface 182, and the memory 186 are electrically and/or communicatively coupled to the one or more processors 184.

In an implementation, the user interface 180 receives input from a user and provides information to the user associated with the operation of the system 100 and/or an analysis taking place. The user interface 180 may include a touch screen, a display, a key board, a speaker(s), a mouse, a track ball, and/or a voice recognition system. The touch screen and/or the display may display a graphical user interface (GUI).

In an implementation, the communication interface 182 enables communication between the system 100 and a remote system(s) (e.g., computers) via a network(s). The network(s) may include an intranet, a local-area network (LAN), a wide-area network (WAN), the intranet, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 184 and/or the system 100 may include one or more of a processor-based system(s) or a microprocessor-based system(s). In some implementations, the one or more processors 184 and/or the system 100 includes a reduced-instruction set computer(s) (RISC), an application specific integrated circuit(s) (ASICs), a field programmable gate array(s) (FPGAs), a field programmable logic device(s) (FPLD(s)), a logic circuit(s), and/or another logic-based device executing various functions including the ones described herein.

The memory 186 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

FIG. 2 is a cross-sectional view of an implementation of a well assembly 200 that can be used to implement the well assembly 124 of FIG. 1. In the implementation shown, the well 128 includes a first well portion 202 and a second well portion 204, where the first well portion 202 and the second well portion 204 are concentric and the body 126 forms a shoulder 206 between the first well portion 202 and the second well portion 204 that is engaged by the insert 130.

The dry reagent 140 is shown being within the second well portion 204 and the insert 130 is shown being positioned within the first well portion 202 and within a dimensional envelope of the first well portion 202. In other implementations, the insert 130 can extend out from the first well portion 202 and, as such, the insert 130 may not be positioned within the dimensional envelope of the well 128 and/or within the dimensional envelope of the first well portion 204.

Referring to the insert 130, in the implementation shown, the sidewall 132 of the insert 130 has a first end 208 and a second end 210, with the opening 134 being disposed at the first end 208 of the insert 130 and a second opening 212 disposed at the second end 210 of the insert 130. The venting membrane 136 is coupled to the insert 130 and covers the first opening 134 and the cover 148 is coupled to the insert 130 at the second end 210 and covers the second opening 212. The cover 148 is shown including a lip 214 that outwardly extends from the insert 130 and is coupled to the distal end 150 of the body 116. The cover 148 being coupled to the insert 130 and the body 116 may seal (e.g., hermetically seal) the well 128.

In some implementations, the cover 148 is coupled to the insert 130 prior to the insert 130 being received within the well 128 and, as such, the cover 148 may be coupled to the distal end 150 of the body 116 after the insert 130 is received within the well 128. In such examples, the cover 148 may be coupled to the body 116 after the insert 130 is received within the well 128. In other implementations, the cover 148 may not be coupled to the insert 130 prior to the insert 130 being received within the well 130 and, as such, the cover 148 may be coupled to both the insert 130 and the body 126 after the insert 130 is received within the well 130.

Regardless of how the cover 148 is coupled to the insert 130 and/or to the body 126, in the implementation shown, the coupling 138 between the insert 130 and the body 126 is shown being a snap-fit connection 216. To form the snap-fit connection 216, the body 126 includes one or more protrusions 218 and the sidewall 132 of the insert 130 includes a groove 220 that receives the one or more protrusions 218. The protrusions 218 may be radially spaced and the groove 220 may be an annular groove. Alternatively, the protrusions 218 may be formed as an annular protrusion. Also, while the body 126 is shown including the protrusions 218 and the insert 130 is shown including the groove 220, the body 126 may include the groove 220 and the insert 130 may include the protrusions 218 or the coupling between the insert 130 and the body 126 may be formed in a different way.

FIG. 3 is a cross-sectional view of an implementation of a plurality of well assemblies 300 that can be used to implement the well assembly 124 of FIG. 1. In the implementation shown, the body 126 includes a plurality of wells 128 that each receive a corresponding insert 130. In contrast to the inserts 130 of FIG. 2, the inserts 130 of FIG. 3 are dosators 302 that may be referred to dosator pipettes and/or dosator cups.

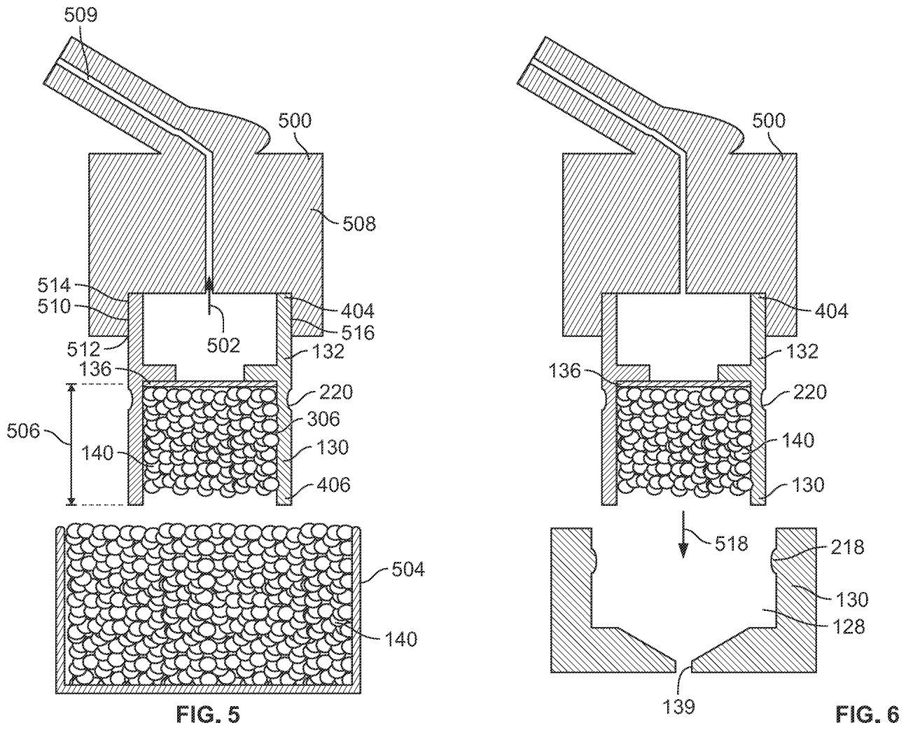

The dosators 302 can be advantageously used during assembly to deposit the dry reagent 140 within the corresponding wells 128. For example and as described in more detail in association with FIGS. 5-8, a tool 500 such as an arm of a robot, is used to grip the insert 130/dosator 302 and aspirate the dry reagent 140 into the insert 130/dosator 302 prior to the tool 500 positioning the insert 130/dosator 302 carrying the dry reagent 140 into the corresponding well 128 and forming the coupling 138 between the insert 130/dosator 302 and the body 126. After the insert 130/dosator 302 is positioned within the well 128 and the tool 500 releases the insert 130/dosator 302, the cover 148 is coupled to the insert 130 and the distal end 150 of the well wall 153.

Referring still to the well assemblies 300 of FIG. 3, in the implementation shown, the insert 130 includes the sidewall 132 and an inward projecting flange 304 to which the venting membrane 136 is coupled such that the sidewall 132 and the venting membrane 136 define a chamber portion 306 in which the dry reagent 140 is housed. The sidewall 132 defines a first opening 308 of the chamber portion 306 that faces a base surface 310 of the body 116 defining the well 128 and the flange 304 defines a second opening 312 of the chamber portion 306 that allows gas to vent through the venting membrane 136. The base surface 310 includes an inward tapered surface 314 that extends toward the port 139 and defines the well 128 and encourages fluid to flow toward the port 139.

The cover 148 is shown spaced above and away from the venting membrane 136 by a gap. The gap allows the cover 148 to be pierced without adversely affecting the venting membrane 136. Additionally, in this implementation, the cover 148 has a diameter larger than a diameter of the venting membrane 136 to allow the cover 148 to be coupled to both the insert 130 and the body 126. The venting membranes 136 and/or the covers 148 may be coupled to the body 126 using adhesive and/or by heat sealing, laser welding, and/or ultrasonic welding. However, other coupling techniques my prove suitable.

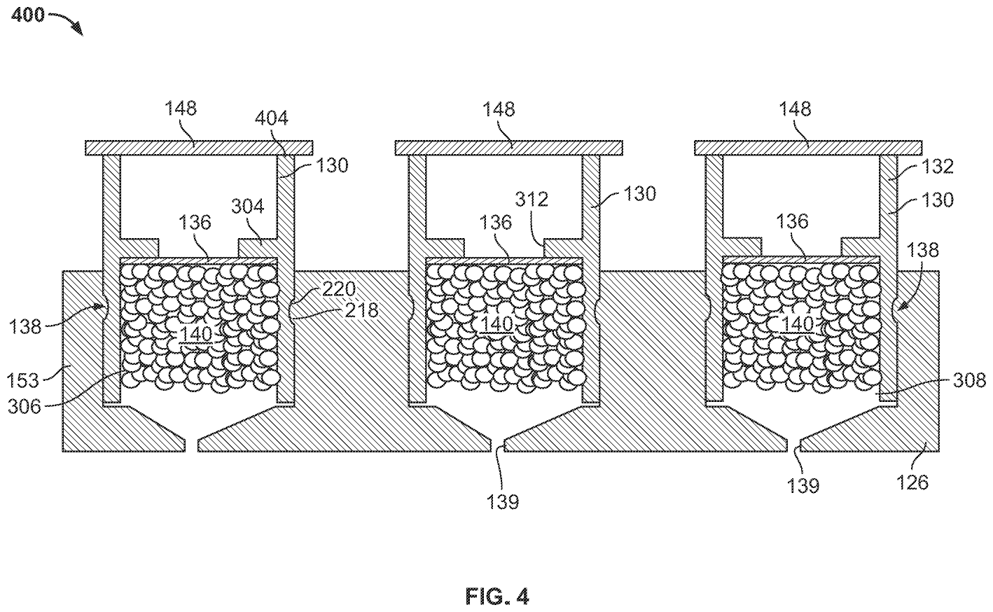

FIG. 4 is a cross-sectional view of an implementation of a plurality of well assemblies 400 that can be used to implement the well assembly 124 of FIG. 1. The well assemblies 400 of FIG. 4 are similar to the well assemblies 300 of FIG. 3. However, in contrast, the well wall 153 of the well assembly 400 of FIG. 4 is shorter as compared to the well wall 153 of the well assemblies of FIG. 3. As such, the insert 130 extends outside of a dimensional envelope of the well 128 and the cover 148 is coupled an end 404 of the insert 130 but the cover 148 is not coupled to the well wall 153.

FIGS. 5-8 illustrate a process of assembling one of the well assemblies of FIG. 4.

FIG. 5 illustrates a cross-sectional view of the tool 500 gripping the end 404 of the insert 130 and creating a vacuum in a direction generally indicated by arrow 502 to draw the dry reagent 140 from a container 504 into the chamber portion 306 of the insert 130. The venting membrane 136 is spaced a distance 506 from an end 406 of the insert 130 to define a volume of the chamber portion 306. As such, when the dry reagent 140 is drawn into the chamber portion 306, a defined amount of the dry reagent 140 may be captured within the insert 130. Such an approach of using the insert 130 as the dosator 302 reduces cross-contamination between wells 128 and/or reduces the likelihood of the dosator 302 becoming clogged given that the dosator 302 is being used for a single well 128. While the venting membrane 136 is shown in a particular position, the location of the venting membrane 136 can be changed to change an amount and/or a dose of the dry reagent 140 drawn into the insert 130.

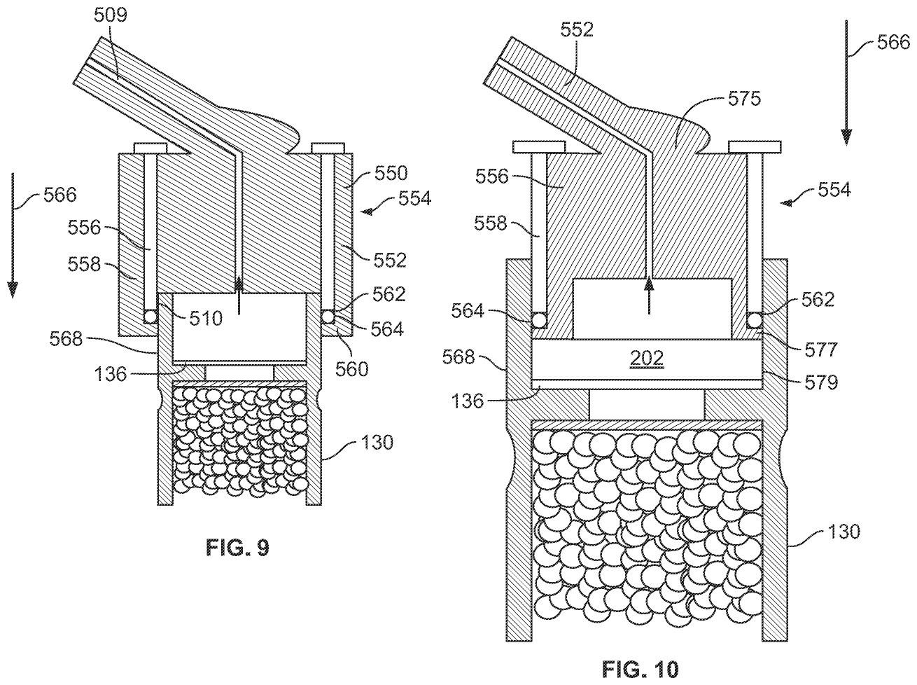

Referring to the tool 500, in the implementation shown, the tool 500 includes a head 508 defining a fluid line 509 and a receptacle 510 fluidly coupled to the fluid line 509 and having an opening 512 to allow the end 404 of the insert 130 to be received within the receptacle 510. In some implementations, the insert 130 is coupled and/or held within the receptacle 510 of the head 508 by the vacuum created by the tool 500 and/or by an interference fit formed between the insert 130 and a surface 514 of the head 508 defining the receptacle 510. Additionally or alternatively, the surface 514 may include surface structures 516 such as, for example, protrusions, that facilitate a coupling between the insert 130 and the tool 500 and/or the head 508 may carry an actuator (see, for example, FIGS. 9 and 10) that can be actuated into engagement with the insert 130 to couple and/or retain the insert 130 within the receptacle 510.

FIG. 6 illustrates a cross-sectional view of the tool 500 holding the insert 130 carrying the dry reagent 140 positioned above the well 128 of the body 126 and the insert 130 being moved toward the well 128 in a direction generally indicated by arrow 518.

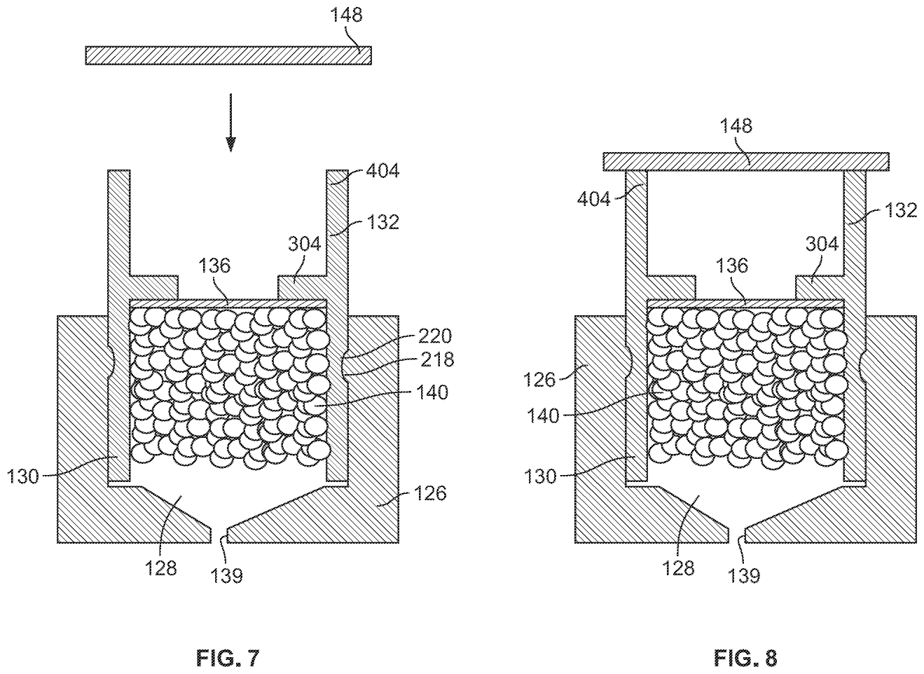

FIG. 7 illustrates a cross-sectional view of the insert 130 positioned within the well 128 and the cover 148 being aligned with the insert 130 prior to the cover 148 being coupled to the insert 130.

FIG. 8 illustrates a cross-sectional view of the insert 130 positioned within the well 128 and the cover 148 coupled to the end 404 of the insert 130. The cover 148 may be coupled to the insert 130 by heat sealing, laser welding, ultrasonic welding, pressure-sensitive adhesive (PSA), or any other suitable method.

FIG. 9 is a cross-sectional view of another tool 550 that can be used to assemble the well assemblies disclosed. The tool 550 of FIG. 9 is similar to the tool 500 of FIG. 5. However, in contrast, the tool 550 of FIG. 9 includes a head 552 including an actuator 554 that facilitates the coupling between the insert 130 and the tool 550. In the implementation shown, the actuator 554 includes an inner sleeve 556 and an outer sleeve 558 including an inward facing lip 560 that forms a seal groove 562. The inner sleeve 556 may be referred to as an inner portion and the outer sleeve 558 may be referred to as an outer portion. The inner sleeve 556 is concentric with the outer sleeve 558 and is substantially coaxial with the lip 560 and a seal 564 is positioned within the seal groove 562.

When the actuator 554 is actuated, the inner sleeve 556 is movable toward the lip 560 in a direction generally indicated by arrow 566 to engage and compress the seal 564 and urge the seal 564 out of the seal groove 562 and into sealing engagement with an outer surface 568 of the insert 130. More specifically, the seal 564 is compressed in the direction generally indicated by the arrow 566 and/or along a vertical axis and expands in radial directions, thereby sealingly engaging the outer surface 568 of the insert 130 and the outer sleeve 558 of the tool 500. The engagement between the seal 564 and the insert 130 retains the insert 130 within the receptacle 510. Moreover, a pneumatic seal may be provided between the insert 130 and the tool 550 that enables a vacuum to be applied to the insert 130 and for the dry reagent 140 to be aspirated into the insert 130 and retained therein as the insert 130 and the dry reagent 140 are being positioned within the well 128. To release the insert 130, the inner sleeve 556 may be moved in a direction opposite that of the arrow 566, thereby allowing the seal 564 to move back into the seal groove 562 and reducing the engagement between the seal 564 and the insert 130 and/or an amount of force imparted onto the insert 130 by the seal 564.

FIG. 10 is a cross-sectional view of another tool 575 that can be used to assemble the well assemblies disclosed. The tool 575 of FIG. 10 is similar to the tool 550 of FIG. 9. However, in contrast, the tool 575 of FIG. 10 is positioned within an interior portion of the insert 130 and/or within the first well portion 202 of the insert 130 and includes the inner sleeve 556 having an outward facing lip 577 that forms the seal groove 562 and includes the outer sleeve 558 that is concentric with the inner sleeve 556 and is substantially coaxial with the lip 577. When the actuator 554 is actuated, the outer sleeve 558 is movable toward the lip 577 in a direction generally indicated by arrow 566 to engage and compress the seal 564 and urge the seal 564 out of the seal groove 562 and into sealing engagement with an inner surface 579 of the insert 130.

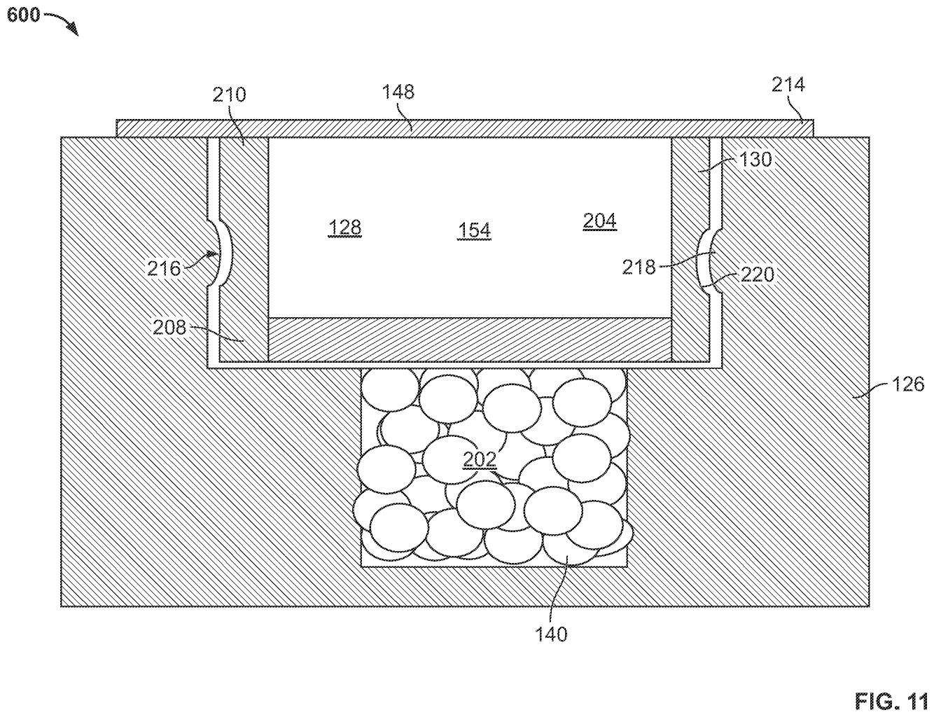

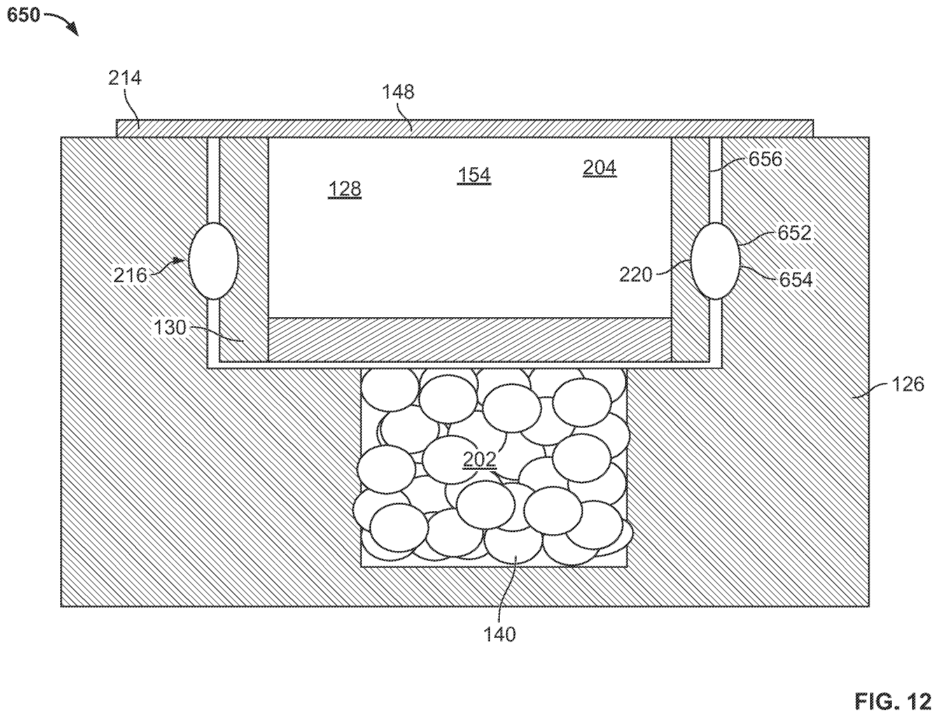

FIG. 11 is a cross-sectional view of an implementation of a well assembly 600 that can be used to implement the well assembly 124 of FIG. 1. The well assembly 600 of FIG. 11 is similar to the well assembly 200 of FIG. 2. However, in contrast, the well assembly 600 of FIG. 11 does not include the port 139. As such, the well assembly 600 can be used with systems that include reagent sippers 802 (see, FIG. 11) that can pierce the venting membrane 136 and/or the cover 148 and flow liquid into and/or out of the well 128 to rehydrate and/or mix the dry reagent 140. In other implementations, the venting membrane and/or the cover 148 may be pierced in other ways.

FIG. 12 is a cross-sectional view of an implementation of a well assembly 650 that can be used to implement the well assembly 124 of FIG. 1. The well assembly 650 of FIG. 12 is similar to the well assembly 600 of FIG. 6. However, in contrast, the snap-fit connection 216 between the insert 130 and the body 126 is formed by a seal 652 being received within the groove 220 of the insert 130 and an opposing groove 654 of the body 126. The interaction between the seal 652 and the insert 130 and the body 126 may retain the insert 130 within the body 126 and/or provide a seal (e.g., a radial seal) at an interface 656 between the insert 130 and the body 126.

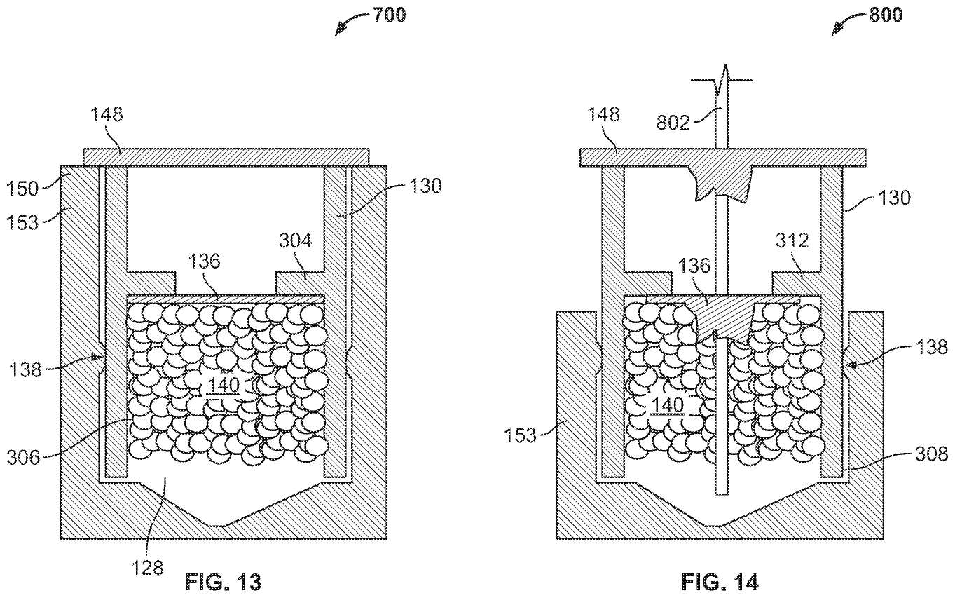

FIG. 13 is a cross-sectional view of an implementation of a well assembly 700 that can be used to implement the well assembly 124 of FIG. 1. The well assembly 700 of FIG. 13 is similar to one of the well assembly 300 of FIG. 3. However, in contrast, the well assembly 700 of FIG. 13 does not include the port 139. As such, the well assembly 700 can be used with systems that include the reagent sippers 802 (see, FIG. 13) that can pierce the venting membrane 136 and/or the cover 148 and flow liquid into and/or out of the well 128 to rehydrate and/or mix the dry reagent 140.

FIG. 14 is a cross-sectional view of an implementation of a well assembly 800 that can be used to implement the well assembly 124 of FIG. 1. The well assembly 800 of FIG. 14 is similar to one of the well assembly 400 of FIG. 4. However, in contrast, the well assembly 700 of FIG. 14 does not include the port 139. As such, the well assembly 800 can be used with systems that include the reagent sippers 802 that can pierce the venting membrane 136 and/or the cover 148 and flow liquid into and/or out of the well 128 to rehydrate and/or mix the dry reagent 140.

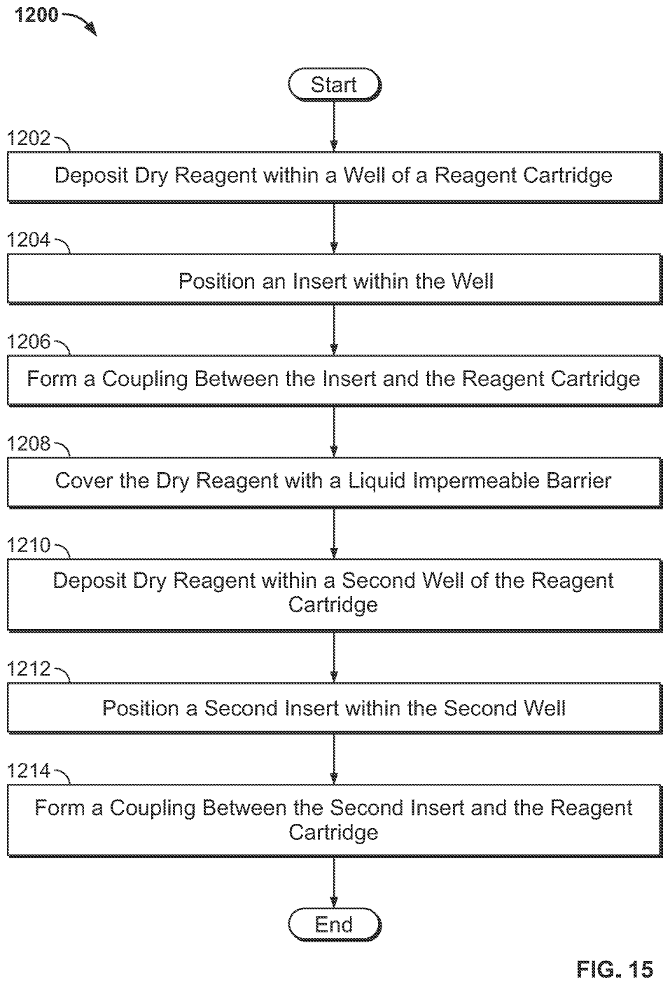

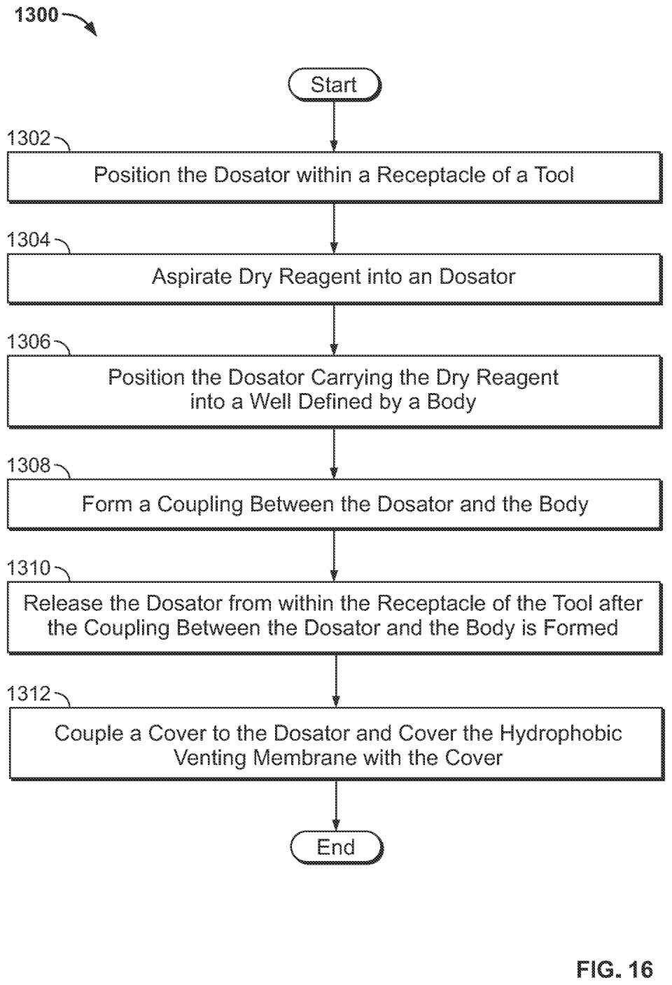

FIGS. 15 and 16 illustrate flowcharts for a method of assembling the well assemblies 124, 200, 300, 400, 600, 650, 675, 700, 800, or any of the disclosed implementations. The order of execution of the blocks may be changed, and/or some of the blocks described may be changed, eliminated, combined, and/or subdivided into multiple blocks.

The process 1200 of FIG. 15 begins by dry reagent 140 being deposited within a well 128 of a reagent cartridge 102 (Block 1202). In some implementations, depositing the dry reagent 140 within the well 128 of the reagent cartridge 102 includes depositing the dry reagent 140 within the first well portion 202 of the well 128 and positioning the insert 130 within the well 128 includes positioning the insert 130 within the second well portion 204 of the well 128 that is concentric with the first well portion 202. In other implementations, depositing the dry reagent 140 within the well 128 includes aspirating the dry reagent 140 into a chamber portion 306 of the insert 130 and positioning the insert 130 into the well 128. In such implementations, the venting membrane 136 is located within the insert 130 to define a volume of the chamber portion 306.

The insert 130 is positioned within the well 128 (Block 1204) and a coupling 138 is formed between the insert 130 and the reagent cartridge 102 (Block 1206). The insert 130 includes the sidewall 132 having an opening 134 and a venting membrane 136 is coupled to the insert 130 and covers the opening 134. In some implementations, forming the coupling 138 between the insert 130 and the reagent cartridge 102 includes forming a snap-fit connection 216 between the insert 130 and the reagent cartridge 102. In other implementations, forming the coupling 138 between the insert 130 and the reagent cartridge 102 includes ultrasonically welding the insert 130 and the reagent cartridge 102.

The dry reagent 140 is covered with the liquid impermeable barrier 148 (Block 1208). In some implementations, covering the dry reagent 140 with the liquid impermeable barrier 148 includes heat sealing the liquid impermeable barrier 148 to a distal end 210, 404 of the insert 130 and the reagent cartridge 102. In other implementations, covering the dry reagent 140 with the liquid impermeable barrier 148 includes heat sealing the liquid impermeable barrier 148 to a distal end 210, 404 of the insert 130 but not coupling the liquid impermeable barrier 148 to the reagent cartridge 102.

Dry reagent 140 is deposited into a second well 128 of the reagent cartridge 102 (Block 1210), a second insert 130 is positioned within a second well 128 (Block 1212), and a coupling 138 is formed between the second insert 130 and the reagent cartridge 102 (Block 1214).

The process 1300 of FIG. 16 begins by positioning the dosator 130, 302 within a receptacle 510 of a tool 500 (Block 1302). In some implementations, positioning the dosator 130, 302 within the receptacle 510 of the tool 500 includes coupling the dosator 130, 302 within the receptacle 510 based on a vacuum generated by the tool 500. In some implementations, positioning the dosator 130, 302 within the receptacle 510 of the tool 500 includes coupling the dosator 130, 302 within the receptacle 510 based on an interference fit between the tool 500 and the dosator 130, 302.

Dry reagent 140 is aspirated into the dosator 130, 302 (Block 1304). In some implementations, aspirating the dry reagent 140 into the dosator 130, 302 includes generating a vacuum using the tool 500 to aspirate the dry reagent 140 into the dosator 130, 302. In some implementations, aspirating the dry reagent 140 into the dosator 130, 302 includes controlling an amount of the dry reagent 140 received within a chamber portion 306 of the dosator 130, 302 based on a location of a venting membrane 136 within the dosator 130, 302.

The dosator 130, 302 carrying the dry reagent 140 is positioned into a well 128 defined by a body 126 (Block 1306) and a coupling 138 is formed between the dosator 130, 302 and the body 126 (Block 1308). In some implementations, forming the coupling between the dosator 130, 302 and the body 126 includes forming a snap-fit connection 216 between the dosator 130, 302 and the body 126. The dosator 130, 302 is released from within the receptacle 510 of the tool 500 after the coupling 138 between the dosator 130, 302 and the body 126 is formed (Block 1310). The tool 500 may release the dosator 130, 302 my stopping the vacuum from being generated and/or in any other suitable way. The cover 148 is coupled to the dosator 130, 302 and the venting membrane 136 is covered with the cover 148 (Block 1312).

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a well assembly, comprising:
a body having a well; and
an insert, comprising:
a sidewall defining an opening; and
a venting membrane coupled to the insert and extending across the opening,
wherein the insert is received within the well and wherein a coupling is formed between the sidewall of the insert and the body.

2. The apparatus of claim 1, wherein the venting membrane is overmolded onto the insert.

3. The apparatus of claim 1, wherein the coupling comprises a snap-fit connection or a weld.

4. (canceled)

5. (canceled)

6. The apparatus of claim 1, further comprising a cover coupled to the insert and covering the venting membrane.

7. The apparatus of claim 6, wherein the cover is a liquid impermeable barrier.

8. (canceled)

9. The apparatus of claim 6, wherein the cover forms at least part of a dead end.

10. The apparatus of claim 6, wherein the cover is coupled to the well and forms an enclosure that captures gas that vents through the venting membrane.

11. (canceled)

12. (canceled)

13. The apparatus of claim 1, wherein the body includes one or more protrusions that extend into the well and the sidewall of the insert comprises a groove that receives the one or more protrusions to form a snap-fit connection.

14. (canceled)

15. The apparatus of claim 1, wherein the well comprises a first well portion and a second well portion, and the insert is received within the first well portion, wherein the body forms a shoulder that is engaged by the insert, wherein the first well portion and the second well portion are concentric, further comprising dry reagent within the second well portion.

16-18. (canceled)

19. The apparatus of claim 1, wherein the sidewall has a first end, a second end, and a second opening, the opening positioned at the first end of the sidewall and the second opening positioned at the second end of the sidewall, further comprising a cover coupled to the second end of the sidewall and covering the second opening.

20. (canceled)

21. The apparatus of claim 2, wherein the well comprises dry reagent and wherein the sidewall and the venting membrane define a chamber portion in which dry reagent is housed.

22. The apparatus of claim 2, wherein the insert comprises the sidewall and an inward projecting flange and wherein the venting membrane is coupled to the inward projecting flange, wherein the inward projecting flange, the venting membrane, and the sidewall form a chamber portion having an opening, wherein the chamber portion is received within the well, wherein the opening of the chamber portion faces a base surface of the reagent cartridge defining the well, wherein the body comprises a port coupled to the well.

23. (canceled)

24. (canceled)

25. (canceled)

26. The apparatus of claim 1, wherein the body comprises a port coupled to the well, wherein the body comprises an inward tapered surface that extends toward the port and defines the well.

27-45. (canceled)

46. A method, comprising:
aspirating dry reagent into a dosator;
positioning the dosator carrying the dry reagent into a well defined by a body; and
forming a coupling between the dosator and the body.

47. The method of claim 46, further comprising positioning the dosator within a receptacle of a tool and wherein aspirating the dry reagent into the dosator comprises generating a vacuum using the tool to aspirate the dry reagent into the dosator.

48. The method of claim 47, wherein positioning the dosator within the receptacle of the tool comprises coupling the dosator within the receptacle using the vacuum generated.

49. The method of claim 47, further comprising releasing the dosator from within the receptacle of the tool after the coupling between the dosator and the body is formed.

50. The method of claim 46, wherein positioning the dosator within the receptacle of the tool comprises coupling the dosator within the receptacle using an interference fit between the tool and the dosator.

51. The method of claim 46, wherein forming the coupling between the dosator and the body comprises forming a snap-fit connection between the dosator and the body.

52. The method of claim 46, wherein aspirating the dry reagent into the dosator comprises controlling an amount of the dry reagent received within a chamber portion of the dosator based on a location of a venting membrane within the dosator, further comprising coupling a cover to the dosator and covering the venting membrane with the cover.

53-61. (canceled)
